(19) United States
(12) Patent Application Publication
(10) Pub. No.: US 2007/0080811 A1
(43) Pub. Date: Apr. 12, 2007

(54) Fob for RF responsive circuits

(75) Inventors: David J. Venderley, Fort Wayne, IN (US); Victor Felger, Fort Wayne, IN (US); Scott Huth, New Haven, IN (US); Roger Holtzinger, Fort Wayne, IN (US); Keith Martin, Leo, IN (US); Sean Holtzinger, Fort Wayne, IN (US); Joe Sorg, Markle, IN (US); Michael Wintrode, Huntington, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: Midwest Tool & Die Corp.

(21) Appl. No.: 11/245,345

(22) Filed: Oct. 6, 2005

(51) Int. Cl. G08B 13/14

(52) U.S. Cl. 340/572.8

(57) ABSTRACT

A radio frequency identification fob is disclosed which includes a body and a cover engaged with each other as a fob to enclose a radio frequency identification device. The body and the cover are typically molded plastic. The engagement of the cover to the body may be via an elongated alignment ridge coupled in slideable manner in an elongated mating groove substantially along the major axis of the body. The cover may be secured engaged with the cover by a fastener that could include a releasable latch engaged with a catch. The fob could further include an attachment device such as a key ring to couple the fob to other personal items.

### TECHNICAL FIELD OF THE INVENTION

The present invention resides generally in the field of enclosures for electronic circuits, and more particularly, but not exclusively, relates to a fob for RF responsive circuits.

### BACKGROUND OF THE INVENTION

An increasingly common personal accessory are smart cards which are utilized for diverse applications such as access control, biometrics, cashless payment and customer loyalty programs. These smart cards utilize transponders such as radio frequency identification (RFID) integrated circuit electronics to exchange information with a host system via radio signaling. These smart cards are intended to be readily portable by an individual so as to be routinely carried by people. Thus, the RFID integrated circuits have been incorporated into small housings such as: a fob attachable to a key ring or other personal items; or a thin card such as a credit card or an identification card. The housing also serves to protect and preserve the electrical circuitry of these devices from the environment entailed in being frequently carried in a purse or pocket: inadvertent dropping, knocking, banging and hitting against hard objects. The housing can also protect against the introduction of foreign material to the electronics either from moisture by rain, mist or inadvertent dropping in water puddles or foreign particles such as dust, dirt and sand which can inadvertently occur in common use of the smart card.

Most housings are either sealed around the integrated circuit electronics or the integrated circuit electronics are molded or formed directly inside the card or fob. However, this type of housing prevents access to the integrated circuit for repair, replacement or modification.

### SUMMARY OF THE INVENTION

A portable radio frequency identification device fob is disclosed which includes a body having an interior volume adapted to partially enclose a radio frequency identification device while permitting the insertion or removal of the radio frequency identification device. A cover slides along the longest axis of the body to engage the body. This engagement results in complete enclosure of the radio frequency identification device inside the body and the cover so that the radio frequency identification device can no longer be removed from the body while the cover is engaged.

In one embodiment, the present disclosure provides a portable radio frequency identification device fob with a body having an interior volume adapted to partially enclose a radio frequency identification device. A cover slides substantially along the longest axis of the body to engage the body. This engagement results in complete enclosure of the radio frequency identification device inside the body and cover. A fastener affixes the cover to the body when the cover is engaged with the body.

In one form of the invention, a portable radio frequency identification device fob is disclosed with a body having an interior volume adapted to partially enclose a radio frequency identification device. A cover is engagable with the body resulting in complete enclosure of the radio frequency identification device inside the body and cover. A fastener which can be easily disengaged affixes the cover to the body when the cover is engaged with the body. An attaching device is coupled to either the body or the cover.

In another form of the invention, a housing for a portable radio frequency identification device fob is disclosed with a body having a first side wall, a second side wall and a front end wall with either an elongated groove or ridge that substantially circumscribes the first side wall, second side wall, and the end wall. A cover with either an elongated ridge if the body has an elongated groove or an elongated groove if the body has an elongated ridge is engagable with the body by a sliding movement substantially along the longest axis of the body using the elongated groove and ridge. The body and cover define an inner volume that is adapted to enclose a radio frequency identification device. A fixing mechanism made up of a latch, catch and a release aperture secures the cover to the body, the release aperture allows the latch to be easily disengaged from the catch, allowing the cover to be removed from the body. An attaching device is coupled to either the cover or the body.

There are many advantages that flow from some of the embodiments of this invention. Some embodiments of this fob are molded out of plastic which provides inexpensive manufacturing and potentially provides the ability to manufacture surfaces that are somewhat resistant to moisture penetration without the use of gasket material, potentially making the fob water resistant, but not waterproof. In addition the plastic fob provides some insulation for the enclosed radio frequency identification device electronics from external voltage and protects the electric circuitry from physical damage and foreign materials. Other embodiments allow for repeated access to the radio frequency identification device electronics permitting actions such as changing batteries or switch settings, repairing or replacing the electric circuitry. In yet another embodiment the fob provides a decorative device that is convenient to carry. In still another embodiment the fob is coupled with a key on a key ring making locating the key easier.

Other objects, embodiments, forms, features, advantages, aspects, and benefits of the present invention shall become apparent from the detailed description and drawings included herein.

### BRIEF DESCRIPTION OF THE DRAWINGS

FIG. 1 is a perspective view of an assembled fob illustrating the invention.

FIG. 2 is a perspective view of the disassembled cover and base of FIG. 1.

FIG. 3 is a cross-sectional view of the assembled fob taken along line 3-3 of FIG. 1.

FIG. 3(a) is an exploded cross-sectional view of FIG. 3 illustrating the disengagement mechanism also taken along line 3-3 of FIG.1.

FIG. 4 is a bottom view of the fob of FIG. 1.

FIG. 5 is a perspective view of the body of FIG. 1.

FIG. 6 is a perspective view of the cover of FIG. 1 taken from below.

### DETAILED DESCRIPTION OF THE PREFERRED EMBODIMENTS

While the present invention may be embodied in many different forms, for the purpose of promoting an understanding of the principles of the present invention, reference will now be made to the embodiments illustrated in the drawings, and specific language will be used to describe the same. It will nevertheless be understood that no limitation of the scope of the invention is thereby intended. Any alterations and further modifications in the described embodiments and any further applications of the principles of the present invention as described herein are contemplated as would normally occur to one skilled in the art to which the invention relates.

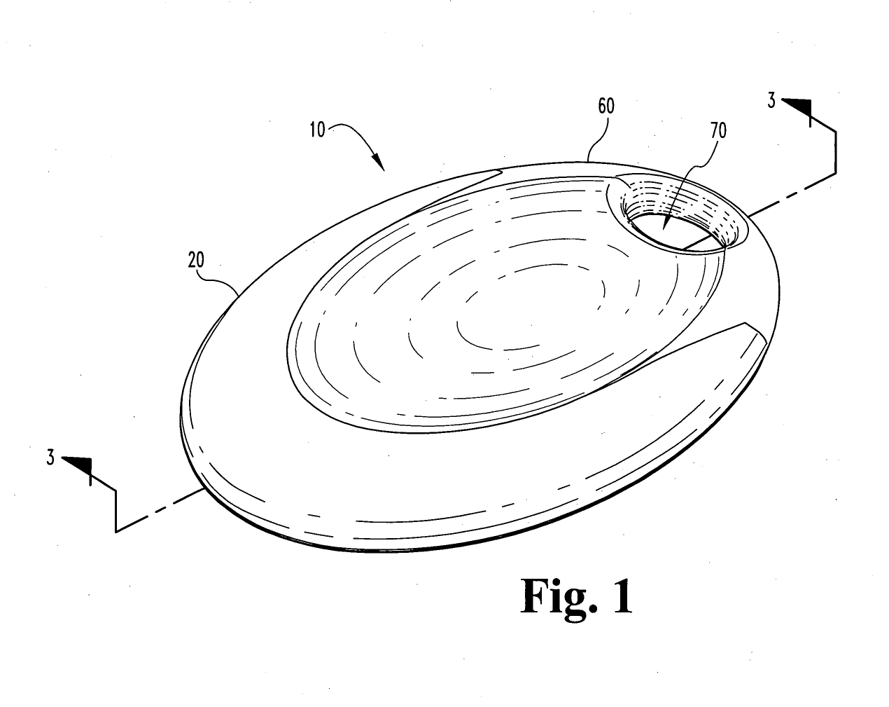

A preferred embodiment of a portable radio frequency identification device fob is illustrated in FIGS. 1-6. Fob 10 is assembled from cover 60 engaged with body 20 as illustrated in FIG. 1 which is a perspective view of assembled fob 10.

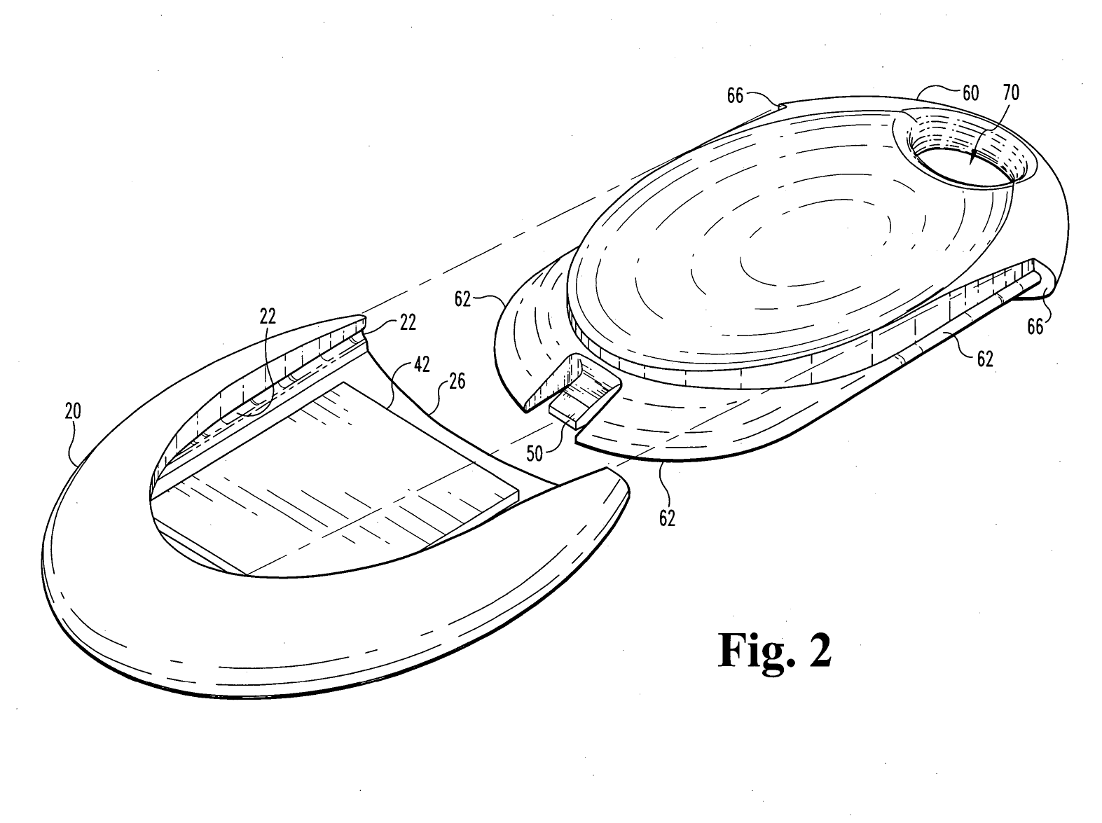

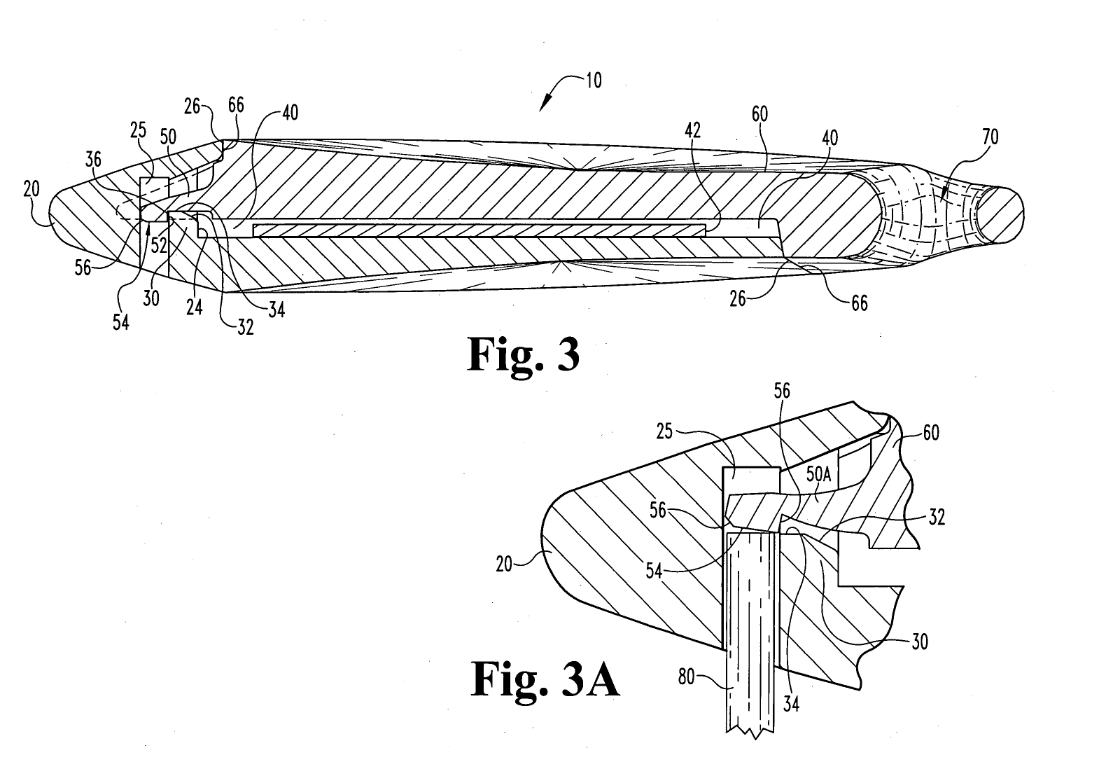

The engagement of cover 60 onto body 20 is illustrated in FIG. 2 which is an assembly view of the preferred embodiment of fob 10. Body 20 is illustrated partially enclosing radio frequency identification device 42. Radio frequency identification device 42 is shown for illustrative purposes only. The novel fob housing structure described herein may be used with many other electronic devices. Cover 60 includes elongated alignment ridge 62 which preferably has a rounded cross section designed to fit in elongated mating groove 22 as illustrated in FIG. 2. Cover 60 is slideably engagable with body 20 though a sliding motion guided by elongated alignment ridge 62 riding in elongated mating groove 22. This slideably motion is preferably substantially along the longest axis (not illustrated) of body 20. Elongated alignment ridge 62 and elongated mating groove 22 secures cover 60 from disengaging from base 20 except through sliding disengagement. When cover 60 is engaged with body 20, base mating surface 26 mates with cover mating surface 66 creating interior volume 40 as illustrated in FIG. 3. An electronic device such as radio frequency identification device 42 is located inside fob 10 in interior volume 40. When cover 60 is engaged with body 20 the electronic device is preferably secured within the housing created by cover 60 and body 20 such that the electronic device cannot be accessed or removed. However, when cover 60 is disengaged from body 20 it is preferable that the electronic device can be removed from body 20 allowing its inspection, repair, replacement or other activity requiring direct access to the electronic device.

The preferred embodiment of the fob illustrating the engaged fit of cover 60 onto body 20 is illustrated in FIG. 3 which is a cross sectional view of the assembled fob taken along line 3-3 from FIG. 1. Cover 60 is held affixed with body 20 by either a fixing mechanism or a fastening device or fastener composed of latch 50 preferably formed as part of or conjoining cover 60 and catch 30 preferably formed as part of or conjoining body 20. When latch 50 is engaged with catch 30, the holding edge 36 of catch 30 preferably is located against the holding edge 52 of latch 60 preventing the disengagement of cover 60 from body 20. Engagement of latch 50 with catch 30 preferably automatically occurs when cover 60 is slid onto body 20 causing cover 60 to become affixed to body 20. In the preferred embodiment, the sloped leading edge 56 of latch 50 interfaces with the sloped edge 32 on catch 30. This interface preferably results in the defection of latch 50, allowing bottom edge 54 of latch 50 to pass over top edge 34 of catch 30. When cover 60 is sufficiently engaged into body 20 latch 50 will preferably return approximately to its original shape, preferably moving the bottom edge 54 of latch 50 inside release aperture 25, allowing the automatic engagement of latch 50 over catch 30 such that holding edge 52 is engaged with holding edge 36.

Interior volume 40 is defined by the space inside body 20 engaged with cover 60. Interior volume 40 is large enough to contain an electric device such as radio frequency identification device 42. Radio frequency identification device 42 is illustrated smaller than interior volume 40 but this is for illustrative purposes only. Interior volume 40 only has to be large enough to accommodate the designed electronic device to be housed in fob 10. Alternatively, interior volume 40 could be much larger than the electronic device housed in the fob.

The disengagement of latch 50 from catch 30 is illustrated in FIG. 3(a) which is an exploded cross section from FIG. 3 illustrating latch 50 being disengaged from catch 30 preferably using small tool 80 inserted into release aperture 25, which is an opening for disengagement. Latch 50 is illustrated deflected by small tool 80 into elongated position 50A. In elongated position 50A, holding edge 36 of catch 30 no longer interfaces with holding edge 52 of latch 50 and bottom edge 54 of latch 50 is above top edge 34 of catch 30, allowing cover 60 to be readily disengaged from body 20 by a sliding motion guided by elongated alignment ridge 62 preferably sliding in elongated mating groove 22. Latch 50 is preferably constructed of a material adapted to permit repeated deflection of latch 50 allowing repeated engagement and disengagement of latch 50 from catch 30. Once latch 50 is disengaged from catch 30, cover 60 is preferably no longer affixed and is easily disengagable from body 20 allowing cover 60 to be removed from body 20.

According to the preferred embodiment, small tool 80 is used to disengage latch 50 from catch 30 because release aperture 25 is preferably too narrow to allow a finger (not illustrated) to disengage latch 50 by pushing against bottom edge 54. In addition, bottom edge 54 is preferably recessed in release aperture 25 deep enough that the chance of inadvertent disengagement of latch 50 from catch 30 is diminished. Small tool 80 preferably is narrow enough to pass through release aperture 25 and long enough to reach and deflect latch 50 sufficiently to allow disengagement. On example of a suitable small tool 80 would be a small flat blade screwdriver.

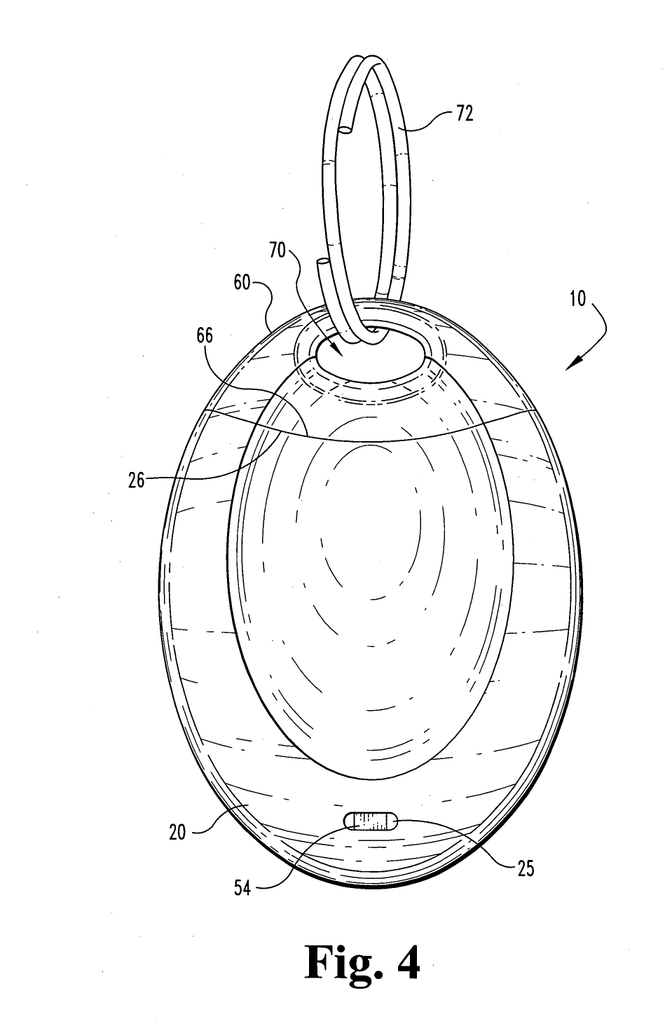

In the preferred embodiment, fob 10 is coupled to an attachment device such as key ring 72 which is coupled or attached to fob 10 through hole 70 as illustrated in FIG. 4. However, it is envisioned that fob 10 could be coupled or attached to many other attachment devices, including, but not limited to, a clip, a lanyard, a chain or jewelry.

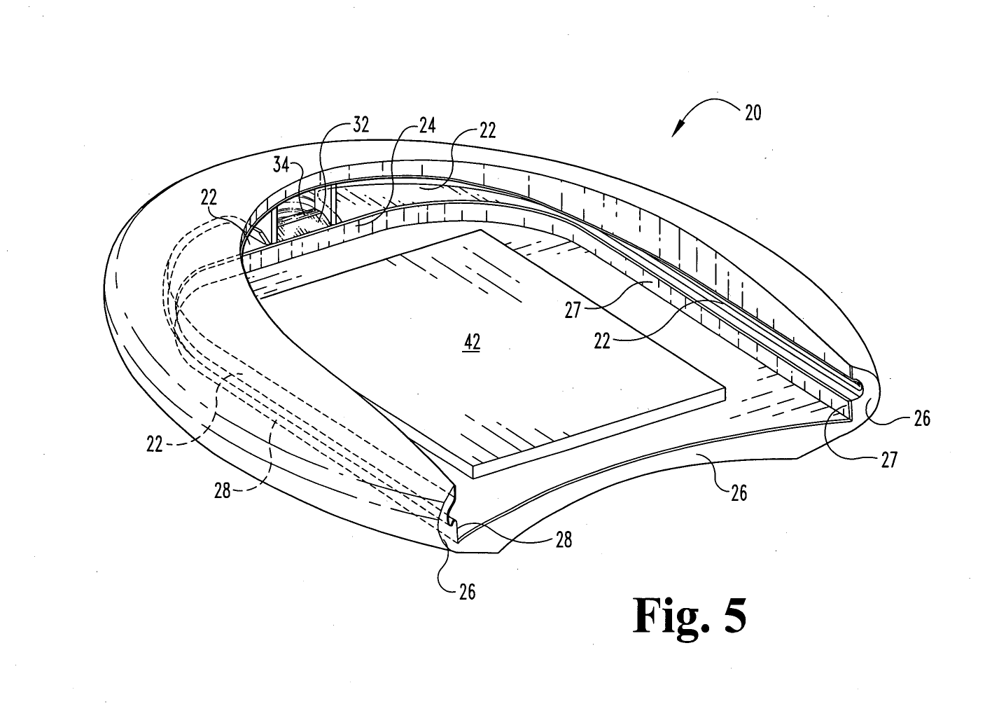

Body 20 is preferably constructed of molded plastic. A suitable plastic is polycarbonate. FIG. 5 is a perspective view of body 20 holding radio frequency identification device 42. Radio frequency identification device 42 is shown as a rectangular box for illustrative purposes only. The actual shape may differ, such as to fit the length, width and height of the space within the fob. Interior volume 40 only has to be large enough to accommodate the designed electronic device to be housed in fob 10. Elongated mating groove 22 preferably substantially circumscribes the circumference of the interior volume of body 20 through first side wall 27 end wall 24 and second side wall 28. Elongated mating groove 22 preferably is substantially parallel with the axis of body 20 along the longest dimension of body 20 (not illustrated) on first side wall 27 and second side wall 28. Elongated mating groove 22 preferably opens up on end wall 24 leaving room for catch 30 preferably molded or conjoined near the middle of end wall 24.

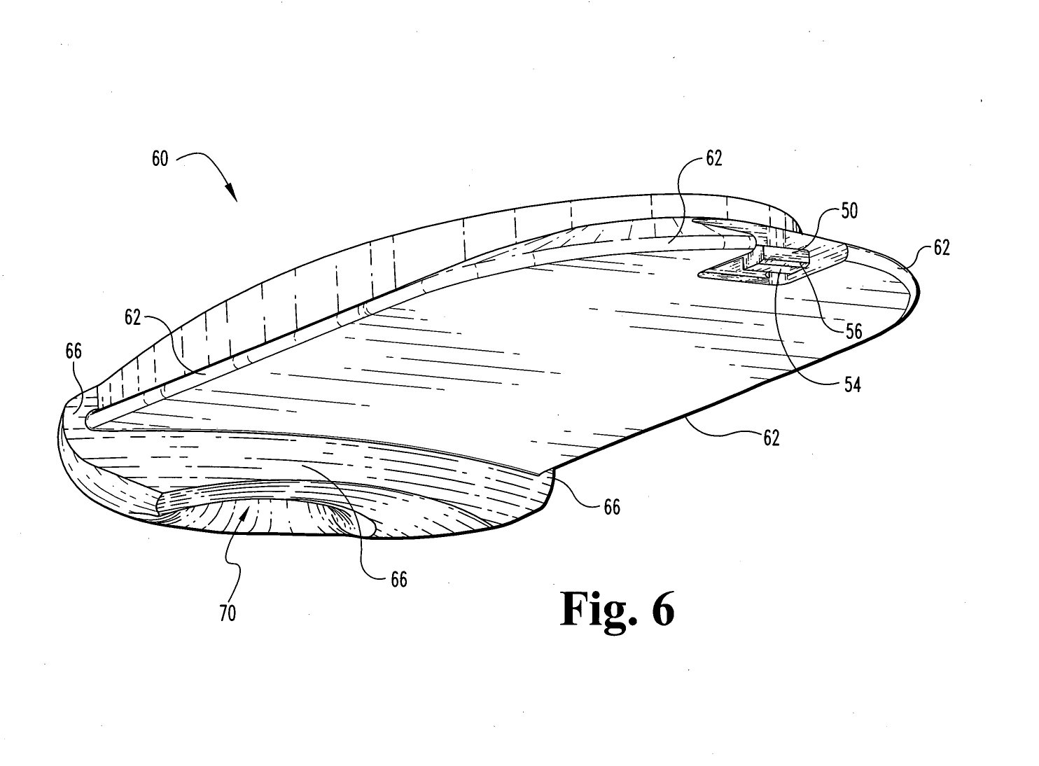

Cover 60 is preferably molded plastic of the same type as the body. FIG. 6 is a perspective view of cover 60 from below. Elongated alignment ridge 62 preferably circumscribes most of the outside circumference of cover 60, with latch 50 preferably located approximately in the middle of the elongated alignment ridge 62 on the end of cover 60.

Radio frequency identification device 42 generally has the capacity to receive a signal and transmit a reply signal in response. Any conventional technique for producing transponder properties as would be known by one in the art could be utilized in radio frequency identification device 42.

In an alternate embodiment, body 20 and cover 60 may have an elastomeric coating (not illustrated). A suitable elastomer is Santoprene TPV. Such a coating could be applied by first injection molding body 20 and cover 60 undersized, then reinjecting the partially filled mold with the desired elastomer, as would be apparent to one skilled in the art.

While the invention has been illustrated and described in detail in the drawings and foregoing description, the same is to be considered as illustrative and not restrictive in character, it being understood that only selected embodiments have been shown and described and that all equivalents, changes, and modifications that come within the spirit of the inventions as defined herein or by the following claims are desired to be protected.

We claim:

1. A portable radio frequency identification device fob comprising:
a radio frequency identification device,
a body having a major axis and an interior volume, said interior volume being adapted to partially enclose said radio frequency identification device, said body being adapted to permit the insertion or removal of said radio frequency identification device from said interior volume,
a cover which is slideably engagable with said body substantially along said major axis, said cover and said body being adapted to enclose said radio frequency identification device when said cover is engaged with said body,
wherein said radio frequency identification device cannot be removed from said interior volume when said cover is slideably engaged along said major axis with said body without slideably disengaging said cover from said body along said major axis.

2. The fob of claim 1 further comprising a hole in said cover or body.

3. The fob of claim 1 further comprising a hole in said cover.

4. The fob of claim 1 in which said body and said cover are plastic.

5. The fob of claim 4 in which said body and said cover are coated with an elastomer.

6. The fob of claim 1 further comprising a fastener that affixes said cover to said body when said cover is engaged with said body.

7. The fob of claim 6 wherein said fastener is adapted to permit repeated disengagement of said cover from said body when it is desired to access said radio frequency identification device.

8. The fob of claim 1 further comprising an attaching device coupled to either said cover or said body.

9. The fob of claim 1 with said body and said cover having an alignment ridge on one and a mating groove on the other.

10. The fob of claim 9 wherein said alignment ridge is on said cover.

11. The fob of claim 10 wherein said alignment ridge has a rounded cross section.

12. The fob of claim 11 in which said body and said cover are plastic.

13. A portable radio frequency identification device fob comprising:
a radio frequency identification device,
a body having a major axis and an interior volume, said interior volume being adapted to partially enclose said radio frequency identification device,
a cover which is slideably engagable with said body substantially along said major axis, said cover and said body being adapted to enclose said radio frequency identification device when said cover is engaged with said body,
a fastener that affixes said cover to said body when said cover is engaged with said body,

14. The fob of claim 13 where said fastener can be disengaged to allow cover removal.

15. The fob of claim 13 where said fastener includes a latch member that is a part of said cover.

16. The fob of claim 14 where said body includes an opening for disengagement.

17. The fob of claim 16 wherein said opening is too small to allow a finger to disengage but is large enough for a small tool to disengage.

18. The fob of claim 13 wherein said fastener automatically affixes said cover to said body when said cover is engaged with said body.

19. A portable radio frequency identification device fob comprising:
a radio frequency identification device,
a body having an interior volume, said interior volume being adapted to partially enclose said radio frequency identification device, said body being adapted to permit the insertion or removal of said radio frequency identification device from said interior volume,
a cover which is engagable with said body, said cover and said body being adapted to enclose said radio frequency identification device when said cover is engaged with said body,
a fastener that affixes said cover to said body when said cover is engaged with said body,
wherein said fastener can be readily disengaged such that said cover is no longer affixed to said body and can be easily disengaged from said body,
an attaching device coupled to either said body or said cover.

20. The fob of claim 19 where said attaching device is a key ring.

21. A housing for a portable radio frequency identification device fob comprising:
a body having a major axis, a first side wall, a second side wall, a end wall, said body further including either an elongated groove or an elongated ridge which substantially circumscribes said first side wall, said second side wall and said end wall,
a cover having either a mating elongated ridge if said body includes an elongated groove or a mating elongated groove if said body includes an elongated ridge enabling said cover to be engaged to said body by relative sliding movement therebetween substantially along said major axis, an inner volume defined by said cover engaged with said body which is adapted to enclose a radio frequency identification device,
a catch and a release aperture proximate to said catch conjoining either said body or said cover,
a latch conjoining either said body or said cover,
a fixing mechanism comprised of said latch, said catch and said release aperture which secures said cover to said body when said cover is engaged with said body by relative sliding movement therebetween substantially along said major axis,
wherein said release aperture permits said latch to be readily disengaged from said catch, allowing said cover to be disengaged from said base by relative sliding movement therebetween substantially along said major axis after having been engaged to said body, and
an attaching device coupled to either said cover or said body.

22. The housing of claim 21 wherein said latch automatically engages said catch when said cover is engaged with said body.

23. The housing of claim 21 wherein said fixing mechanism is adapted to permit repeated disengagement of said cover from said body when it is desired.

24. The housing of claim 21 wherein said release aperture is too small to allow a finger to disengage but is large enough for a small tool to disengage.

25. The housing of claim 21 wherein said attaching device is a key ring.

26. The housing of claim 21 wherein said elongated ridge has a rounded cross section.
